(19) United States
(12) Patent Application Publication
(10) Pub. No.: US 2026/0243596 A1
(43) Pub. Date: Aug. 20, 2026

(54) ASSEMBLY COMPRISING A FLUID DISTRIBUTOR AND A SIMULATOR OF A TANK TO BE FILLED, AND USE OF SUCH AN ASSEMBLY

(71) Applicant: L'Air Liquide, Societe Anonyme pour l'Etude et l’Exploitation des Procedes Georges Claude, Paris (FR)

(72) Inventors: Tom RONY, Aubagne (FR); David VEMPAIRE, Sassenage (FR); Clement GIRE, Sassenage (FR)

(21) Appl. No.: 19/151,450

(22) PCT Filed: Jan. 31, 2024
(86) PCT No.: PCT/EP2024/052314

§ 371 Date: Jul. 28, 2025

(30) Foreign Application Priority Data
Feb. 8, 2023 (FR) FR2301178

(51) Int. Cl. G01F 25/00

(52) U.S. Cl. CPC G01F 25/0092

(57) ABSTRACT

An assembly having a pressurized-fluid distributor and a simulator of a tank to be filled from the distributor. The distributor and the simulator having a main flow meter and a secondary flow meter respectively, the main flow meter being configured to estimate a first quantity of a fluid flow supplied to the pressure controller and thus to the tank simulated by the pressure controller, the secondary flow meter being arranged on the transfer line, downstream of the pressure controller, and configured to measure a second quantity of the fluid flow supplied to the pressure controller and thus to the tank simulated by the pressure controller. Wherein the simulator has a programmable electronic control unit configured to compare the second quantity of the fluid flow with the first quantity of the fluid flow, so as to verify the reliability of the first quantity of the fluid flow.

### CROSS REFERENCE TO RELATED APPLICATIONS

This application is a 371 of International Application No. PCT/EP 2024/052314, filed Jan. 31, 2024, which claims priority to French Patent Application No. FR 2301178, filed Feb. 8, 2023, the entire contents of which are incorporated herein by reference.

### BACKGROUND

Legal metrology refers here to a procedure intended to verify that a quantity of fluid assumed to have been delivered by a distributor to a tank (i.e. a quantity of fluid charged to a customer) corresponds to the quantity of fluid actually delivered to the tank. A need exists within the industry for more accurate measurements.

### SUMMARY

The invention relates to an assembly comprising a fluid distributor and a simulator of a tank to be filled by the distributor.

The invention also relates to the use of such an assembly to check the reliability of the distributor, and in particular, the reliability of measurements supplied and/or displayed by the distributor. More specifically, this involves checking the reliability of a quantity of fluid assumed to have been delivered by the distributor to a tank to be filled.

The fluid in question is pressurized. It may be hydrogen gas or natural gas.

The invention is mainly used in legal metrology applied to pressurized-fluid distributors. Legal metrology refers here to a procedure intended to verify that a quantity of fluid assumed to have been delivered by a distributor to a tank (i.e. a quantity of fluid charged to a customer) corresponds to the quantity of fluid actually delivered to the tank.

However, the invention can be used in industrial metrology or scientific metrology. Industrial metrology is intended to ensure the validity and reliability of measurement results in a voluntary procedure undertaken by a laboratory, organization or industry, etc. Scientific metrology comprises research and development on measurement instruments and techniques with the aim of improving accuracy and fidelity, and consequently greater reliability in all measurements.

To verify/certify the reliability of the quantities of fluid charged/displayed by a distributor, the prevailing legal metrology procedure provides for a test tank connected to the service station and scales to determine the weight of this tank before and after filling. The difference in weight calculated on the test tank before and after filling gives an indication of the amount of fluid actually supplied to said tank. This quantity of fluid is compared to a value displayed by the distributor to establish the reliability of said value.

The test tank is chosen so as to be representative of the tanks found in motor vehicles. For example, the test tank can be a type 3 or 4 tank with a capacity ranging from 100 L to more than 2000 L.

The use of a test tank (of any type) generates significant acquisition and maintenance costs that affect the total cost of the verification/certification operations required for legal metrology. In addition, the use of a test tank involves laborious operations before, during and after the filling test of the test tank.

In particular, after the test tank has been filled, it has to be depressurized for storage and/or transport, and/or for subsequent filling. Since the test tank is fragile, it must not be subjected to temperatures below −40° C. or undergo rapid depressurization. Thus, for a test tank with a capacity of 100 L, for example, depressurization from 700 bar to 30 bar can take more than an hour.

Moreover, an assembly comprising a pressurized-fluid distributor and a simulator of a tank to be filled from the distributor is known. The simulator is connected to the fluid distributor.

In particular, the simulator comprises a transfer line comprising a pressure controller configured to regulate a pressure and/or a flow rate of a fluid flow passing through the transfer line, so as to simulate a pressure rise in the tank to be filled.

The distributor and the simulator comprise a main flow meter and a secondary flow meter, respectively. The main flow meter is configured to determine a first quantity of a fluid flow coming out of the distributor. The secondary flow meter is configured to measure a second quantity of a fluid flow passing through the transfer line.

The assembly described above is used to test the operation of a distributor of a pressurized fluid. In particular, this assembly is used to test the control, regulation and safety components of the distributor in several operating scenarios that it is not always possible or easy to reproduce under real conditions.

These operating scenarios involve a large number of tanks to be filled simultaneously or successively. They consist, for example, of two fillings in quick succession, a variation in the ambient temperature between two successive fillings, successive fillings of tanks at different initial pressures, etc.

To date, the assembly described above has only been used for operating tests on a pressurized-fluid distributor, even though the presence of the pressure controller as a means of simulating a pressure rise in a tank to be filled could be used in other applications where the use of a test tank (i.e. a real tank) poses operational difficulties.

According to a first aspect, the invention relates to an assembly comprising a pressurized-fluid distributor and a simulator of a tank to be filled from the distributor.

In particular, the simulator comprises a transfer line that is connected to the station and comprises a pressure controller configured to regulate a pressure and/or a flow rate of a fluid flow passing through the transfer line. Thus, the pressure controller makes it possible to simulate a pressure rise in the tank to be filled.

The distributor and the simulator comprise a main flow meter and a secondary flow meter, respectively. The main flow meter is configured to estimate a first quantity of the fluid flow supplied to the pressure controller and thus to the tank simulated by the pressure controller. The secondary flow meter is arranged on the transfer line, downstream of the pressure controller, and configured to measure a second quantity of the fluid flow supplied to the pressure controller and thus to the tank simulated by the pressure controller.

According to this first aspect of the invention, the simulator also comprises a programmable electronic control unit configured to compare the second quantity of the fluid flow with the first quantity of the fluid flow, so as to verify the reliability of the first quantity of the fluid flow.

According to a second aspect, the invention relates to the use of the assembly described above to determine more accurately the quantity of fluid supplied to the pressure controller and thus to the tank simulated by the pressure controller. Such accuracy is made possible by the presence of the secondary flow meter downstream of the pressure controller. The secondary flow meter thus plays the role of a flow meter which would be placed inside a tank to be filled.

With an additional measurement of the fluid flow delivered to the pressure controller (which simulates a tank to be filled), a measurement which is available as a result of the presence of the secondary flow meter on the transfer line, and more accurate on account of the positioning of this second flow meter downstream of the pressure controller, it becomes possible to verify the reliability of a quantity of fluid assumed to have been supplied to the pressure controller and determined by the main flow meter.

According to a third aspect, the invention relates to the use of the assembly described above for metrology, in particular for legal metrology, in the field of pressurized-fluid distributors, and notably for checking the reliability of measurements supplied by a pressurized-fluid distributor. In particular, the assembly described above is used to verify the reliability of a flow measurement provided by the main flow meter by comparison with a flow measurement provided by the secondary flow meter.

Thus, the invention according to this third aspect provides a novel approach for verifying and/or certifying data on fluid flow rate or quantity as determined/displayed by a pressurized-fluid distributor.

With this novel approach, the pressure controller replaces the test tank of the prior art. In addition, a flow measurement of a flow passing through the pressure controller replaces the pre-fill and post-fill weighings performed on the test tank according to the prior art.

This novel approach makes it possible to overcome the drawbacks of legal metrology as practiced in the prior art. This simplifies the verification/certification procedure for pressurized-fluid distributors.

Embodiments of the invention according to any of the aspects set out above can include one or more of the following features:
the pressure controller is configured to increase the pressure of the fluid flow upstream of the pressure controller, and to decrease the pressure of the fluid flow after the fluid flow has passed through the pressure controller,
the transfer line has a portion downstream of the pressure controller, referred to as the downstream portion, which has a section larger than a section of a portion of the transfer line located upstream of the pressure controller,
the downstream portion of the transfer line is configured to minimize pressure losses after the fluid has passed through the pressure controller,
the secondary flow meter is arranged in the downstream portion of the transfer line,
the secondary flow meter is more accurate than the main flow meter,
the accuracy of the secondary flow meter is less than 0.004%,
the secondary flow meter is based on a physical quantity or phenomenon different from a physical quantity or phenomenon associated with the main flow meter,
the electronic control unit is configured to modify a resistance of the pressure controller to the flow of the fluid passing through the transfer line, and thus to modify the pressure of the fluid flow passing through the transfer line,
the electronic control unit is controlled using a mathematical model and at least one of the following data measured on the fluid flow passing through the transfer line: flow rate, temperature or pressure,
the flow rate datum is measured by the secondary flow meter located downstream of the pressure controller or by an additional flow meter located upstream or downstream of the pressure controller,
the pressure datum is measured by a pressure sensor arranged upstream of the pressure controller,
the temperature datum is measured by a temperature sensor arranged upstream of the pressure controller,
the transfer line comprises a safety valve and/or an automatic valve configured to protect the simulator in the event of a malfunction,
the transfer line comprises a check valve configured to enable the fluid to flow from the station to the pressure controller and to prevent the fluid from flowing in the opposite direction,
the transfer line comprises a receptacle used to recover the fluid and/or to provide a more accurate and stable check of the pressure applied to the secondary flow meter.

### BRIEF DESCRIPTION OF THE DRAWINGS

Further specific features and advantages will become apparent upon reading the description below, which is provided with reference to the following figures, in which:

FIG. 1 is a schematic view representing an assembly according to the invention, the assembly comprising a pressurized-fluid distributor and a simulator of a tank to be filled from the distributor, the simulator comprising a transfer line provided with a pressure controller;

FIG. 2 illustrates an example curve showing a temporal evolution of the resistance of the pressure controller to a fluid flow through the transfer line in FIG. 1;

FIG. 3 illustrates an example curve showing a temporal evolution of the pressure in a tank being filled from the distributor in FIG. 1.

### DETAILED DESCRIPTION OF THE PREFERRED EMBODIMENTS

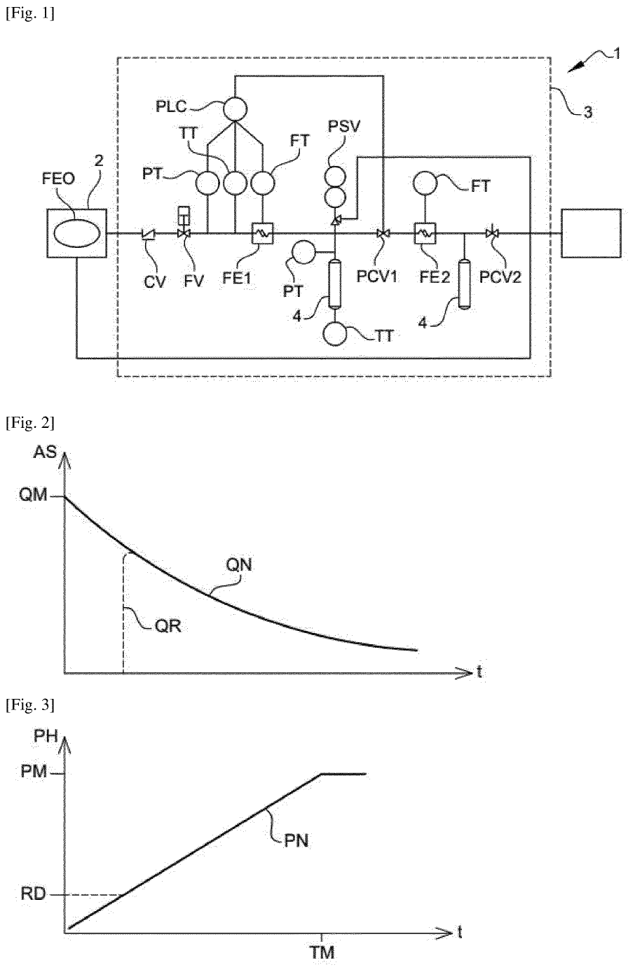

FIG. 1 illustrates an assembly 1 comprising a pressurized-fluid distributor 2 and a simulator 3 of a tank to be filled from the distributor 2. The simulator 3 is connected to the pressurized-fluid distributor 2. The fluid in question may be hydrogen gas or natural gas.

The distributor 2 comprises a pressurized-fluid source and a distribution member connected to the fluid source by a hose. In particular, the distribution member of the distributor 2 is configured to be connected to the simulator 3. In addition, the distribution member of the distributor 2 may be a dispensing nozzle.

In addition, the distributor 2 comprises sensors to measure a certain number of physical quantities of the pressurized fluid. These sensors can be arranged on the hose connecting the source to the distribution member, or on the distribution member. In particular, the distributor 2 comprises a main flow meter FEO which is configured to determine the quantity of fluid coming out of the distributor 2.

It should be noted that the distributor 2 can be used on its own without the simulator 3. The distributor is in nominal operation. In this case, the distribution member of the distributor 2 can be connected to a tank to be filled.

The quantity of fluid coming out of the distributor 2 is taken into account to estimate the volume of fluid supplied to the simulator 3. When the distributor 2 is in nominal operation, the quantity of fluid coming out of the distributor 2 is taken into account to estimate the volume of the fluid supplied to the tank. This estimated volume is used as the basis for calculating the value of the commercial transaction (i.e. the amount charged to the customer at the service station).

The simulator 3 comprises a fluid transfer line in the form of a duct having a first end and an opposing second end. The first end of the duct is configured to be connected to the distributor 2, and more specifically to the distribution member of the distributor 2. The fluid passing through the duct flows from the first end, referred to as the upstream end, to the second end, referred to as the downstream end. It should be noted that the duct can be covered with a thermal insulator.

In particular, the transfer line comprises a pressure controller PCV1, and at least one secondary flow meter FE1, FE2.

The pressure controller PCV1 provides a resistance to the flow of the fluid. This resistance can vary, causing a variation in a flow rate and/or a pressure of a fluid flow passing through the transfer line. In other words, the pressure controller PCV1 is configured to regulate the flow rate and/or the pressure of a fluid flow passing through the transfer line.

In particular, the variation of the resistance of the pressure controller PCV1 may increase the pressure of the fluid flow upstream of the pressure controller PCV1, and decrease the pressure of said flow downstream of the pressure controller, i.e. after this flow has passed through the pressure controller PCV1. This is referred to as regulation of the “upstream pressure” of the fluid by the pressure controller PCV1.

Alternatively, the variation of the resistance of the pressure controller PCV1 may increase the pressure of the fluid after the fluid flow has passed through the pressure controller PCV1. This is referred to as regulation of the “downstream pressure” of the fluid by the pressure controller PCV1.

The variation of the resistance of the pressure controller PCV1 to the flow of the fluid (and therefore the resulting variation in the flow rate and/or the pressure of the fluid) makes it possible to reproduce a pressure rise in a tank simulated by the pressure controller PCV1. The pressure controller PCV1 thus acts as a virtual tank.

The pressure controller PCV1 for example comprises a flow rate and/or pressure regulating valve that has a variable valve area. The valve area determines the resistance of the valve to the flow of the fluid. In other words, the valve area determines the pressure of the fluid downstream and/or upstream of the regulating valve.

The at least one secondary flow meter FE1, FE2 is configured to measure a quantity of fluid passing through the transfer line. More specifically, the at least one secondary flow meter FE1, FE2 is configured to measure a quantity of fluid passing through the pressure controller PCV1. Thus, the at least one secondary flow meter FE1, FE2 may be arranged upstream or downstream of the pressure controller PCV1.

In the example illustrated, the transfer line includes a first secondary flow meter FE1 located upstream of the pressure controller PCV1 and a second secondary flow meter FE2 located downstream of the pressure controller PCV1. Hereinafter, the first secondary flow meter FE1 is also referred to as the “upstream flow meter”. The second secondary flow meter FE2 is similarly referred to as the “downstream flow meter”.

Insofar as the pressure controller PCV1 simulates a tank to be filled, the quantity of fluid measured by the second secondary flow meter FE2 represents a quantity of fluid that would have been supplied to the tank thus simulated by the pressure controller PCV1 Thus, the assembly 1, and in particular the second secondary flow meter FE2, can be used to determine more accurately the quantity of fluid supplied to a tank by the distributor 2, when said tank is simulated by a pressure controller PCV1.

Similarly, the assembly 1, and in particular the second secondary flow meter FE2, can be used to verify the reliability of the data determined using the main flow meter FEO and assumed to represent the volume of fluid delivered to a tank connected to the distributor 2. In other words, the assembly 1, and in particular the second secondary flow meter FE2, can be used for metrology, and notably for legal metrology, in the field of pressurized-fluid distributors.

Since it acts as a measurement standard for the main flow meter FEO, the second secondary flow meter FE2 is also referred to below as the “metrological flow meter”.

Advantageously, the metrological flow meter FE2 is based on a physical quantity or phenomenon different from the one associated with the main flow meter FE0. In other words, the metrological flow meter FE2 and the main flow meter FEO are of different types and/or technologies. For example, the metrological flow meter FE2 may be an electromagnetic flow meter. The main flow meter FEO may be a Coriolis flow meter.

The main flow meter FEO and the metrological flow meter FE2 must be of two different types and/or technologies for a legal metrology application. Indeed, if the two flow meters FE0, FE2 were based on the same physical quantity or phenomenon, in the event of a significant difference in the measurements provided by these flow meters respectively, it may be difficult to determine which of these measurements is erroneous.

To allow a finer measurement of the quantity of fluid passing through the pressure controller PCV1 (and thus a finer measurement of the quantity of fluid that would be supplied to a tank simulated by the pressure controller PCV1), the metrological flow meter FE2 must provide better flow measurement accuracy compared with the upstream flow meter FE1 or the main flow meter FE0.

For this purpose, according to the invention, the transfer line has a portion downstream of the pressure controller PCV1, referred to as the downstream portion, which has a wider section than a portion of the same transfer line located upstream of the pressure controller PCV1. The downstream portion of the transfer line is configured to minimize pressure losses after the flow has passed through the pressure controller PCV1.

With a fluid pressure level that is relatively lower in the downstream portion of the transfer line, the metrological flow meter FE2 arranged on this downstream portion may be chosen from a range of flow meters with higher accuracy.

Advantageously, the accuracy of the metrological flow meter FE2 is less than 0.004%. Such a level of accuracy is generally expected of the measurement means used in a legal metrology procedure applied to a pressurized-fluid distributor.

To control the pressure controller PCV1, the simulator 3 comprises a control unit PLC configured to regulate, using a flow measurement taken on the transfer line, and using a mathematical model, the resistance of the pressure controller PCV1 to the flow of the fluid.

The flow measurement used to control the control unit PLC can be given by the upstream flow meter FE1 or the downstream flow meter FE2. In the second case, the flow meter FE2 then performs an additional function in addition to its metrological function. The flow measurement used to control the control unit PLC can also be determined by an additional secondary flow meter (not illustrated) located downstream of the pressure controller PCV1 and separate from the secondary flow meter FE2.

In particular, the control unit PLC may comprise a servomotor configured to control the pressure controller PCV1, and in particular to act on the resistance of the pressure controller PCV1 according to a predefined setpoint. In addition, the control unit PLC may comprise an electronic control unit including a programmable microprocessor and/or display means and/or input means.

In particular, the microprocessor is configured to receive some or all of the signals coming from the measurement members or sensors such as the upstream flow meter FE1 or the downstream flow meter FE2, and then to send a second signal to the servomotor.

FIG. 2 shows an example setpoint AS sent by the control unit PLC to the pressure controller PCV1. In this case, the pressure controller PCV1 is a valve. The setpoint AS consists of a curve QN giving a temporal variation of the valve area of the valve between a maximum value QM marking the beginning of the flow of the fluid into an initially empty tank, and a minimum value marking the end of the flow into the tank filled to its maximum.

The mathematical model mentioned above is obtained from a filling test carried out on a tank connected to the distributor 2.

This model for example comprises a curve PN giving a temporal evolution of the pressure PH of the fluid coming out of the distributor (see FIG. 3). This evolution can be linear and increase from an initial pressure RD of the tank to a maximum value PM. The initial pressure may be greater than atmospheric pressure.

In addition, this model may comprise a curve (not illustrated) giving a temporal evolution of the flow rate of the fluid coming out of the distributor 2. This evolution can be non-linear and decrease from a maximum value marking a beginning of filling to a minimum value marking an end of filling.

Finally, this model comprises a curve (not illustrated) establishing a correlation between the pressure PH and the flow rate of the fluid coming out of the distributor 2.

The correlation curve between the pressure PH and the flow rate of the fluid coming out of the fluid source can be used with a flow measurement given by the upstream flow meter FE1 and/or the downstream flow meter FE2 to determine a theoretical value of the pressure of the fluid at the pressure controller PCV1. On the basis of this theoretical pressure value, the control unit PLC acts on the resistance of the pressure controller PCV1 (for example according to the setpoint shown in FIG. 2) to set the flow rate through this pressure controller PCV1 to a predetermined value, provided by the pressure/flow rate correlation curve.

As the fluid flows through the transfer line, the curve PN giving the temporal evolution of the pressure PH can be used to determine a value of the fluid pressure at the pressure controller PCV1 at any instant. The resistance of the pressure controller PCV1 is adapted accordingly (for example according to the setpoint illustrated in FIG. 2) to reduce the flow rate of the fluid passing through the pressure controller PCV to a predetermined value, provided by the pressure/flow rate correlation curve.

It should be noted that a curve giving a correlation between the estimated pressure of the fluid at the pressure controller PCV1 and the resistance of the same pressure controller PCV1 can be used by the control unit PLC to regulate the resistance of the pressure controller PCV1. Such a curve can be used instead of the setpoint illustrated in FIG. 2.

It should also be noted that the control unit PLC is also configured to compare a first quantity of fluid determined by the main flow meter and presumed to represent the volume of fluid passing through the pressure controller PCV1 with a second quantity of fluid measured by the metrological flow meter FE2 downstream of the pressure controller PCV1. Such a comparison makes it possible to establish the reliability of the first quantity of fluid.

Advantageously, the transfer line comprises a pressure sensor PT and/or a temperature sensor TT upstream of the pressure controller PCV1. These sensors PT, TT are connected to the control unit PLC and can be used to correct the resistance of the pressure controller PCV1, as given by the mathematical model described above. In the case of a pressure controller PCV1 formed by a regulating valve, the sensors TT, PT enable the opening of the valve area of said valve to be corrected.

Advantageously, the simulator 3 comprises a receptacle 4 intended to collect the fluid circulating through the transfer line.

In particular, the receptacle 4 can be connected to the fluid distributor 2 by a return duct to enable the fluid to be reused in the distributor 2. In a variant, the receptacle 4 may be connected to an ambient environment to vent the fluid. In both cases, the transfer line may be equipped with a second pressure controller PCV2 which is positioned between the receptacle 4 and the distributor 2 or between the receptacle 4 and the ambient environment, as applicable.

If there is fluidic communication between the receptacle 4 and the distributor 2, the second pressure controller PCV2 is intended to regulate the pressure at the output of the receptacle 4 in order to bring this pressure to a value accepted by the distributor 2.

The receptacle 4 may be positioned upstream and/or downstream of the metrological flow meter FE2.

If it is positioned upstream of the metrological flow meter FE2, the receptacle 4 collects a volume of fluid which is liable to give rise to uncertainties in the measurement made by the metrological flow meter FE2. To correct such uncertainties, the receptacle 4 upstream of the metrological flow meter FE2 may be equipped with a temperature sensor TT and/or a pressure sensor.

If it is arranged downstream of the metrological flow meter FE2, the receptacle 4 stabilizes the pressure applied to this metrological flow meter FE2.

It should be noted that the receptacle 4 may be a type I or II receptacle with a more limited capacity (for example 100 L) to allow for faster depressurization. In other words, the receptacle 4 need not be of the same type as a test tank (usually type III or IV) used for example in a legal metrology procedure according to the prior art.

Advantageously, the transfer line may comprise a check valve CV allowing the fluid to flow in just one direction, i.e. from the distributor 2 to the pressure controller PCV1.

Advantageously, the transfer line may comprise a safety valve PSV and/or an automatic valve FV intended to protect the simulator 3 in the event of a malfunction. More specifically, the safety valve PSV and/or the automatic valve FV protect the simulator 3 notably if the temperature, the pressure or the flow rate (measured by the temperature sensor TT, the pressure sensor PT or the at least one secondary flow meter FE1, FE2, respectively) exceeds a maximum allowable threshold.

In the event of a malfunction, the control unit (PLC) is configured to emit a warning signal announcing that the simulator 3 has stopped.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-14. (canceled)

15. An assembly comprising a pressurized-fluid distributor and a simulator of a tank to be filled from the distributor:
the simulator comprising a transfer line connected to the distributor and comprising a pressure controller, the pressure controller being configured to regulate a pressure and/or a flow rate of a fluid flow passing through the transfer line, so as to simulate a pressure rise in the tank to be filled,
the distributor and the simulator comprising a main flow meter and a secondary flow meter respectively, the main flow meter being configured to estimate a first quantity of a fluid flow supplied to the pressure controller and thus to the tank simulated by the pressure controller, the secondary flow meter being arranged on the transfer line, downstream of the pressure controller, and configured to measure a second quantity of the fluid flow supplied to the pressure controller and thus to the tank simulated by the pressure controller,
wherein the simulator comprises a programmable electronic control unit configured to compare the second quantity of the fluid flow with the first quantity of the fluid flow, so as to verify the reliability of the first quantity of the fluid flow.

16. The assembly as claimed in claim 15, wherein the pressure controller is configured to increase the pressure of the fluid flow upstream of the pressure controller, and to decrease the pressure of the fluid flow after the fluid flow has passed through the pressure controller.

17. The assembly as claimed in claim 15, wherein the transfer line has a portion downstream of the pressure controller which has a section larger than a section of a portion of the transfer line located upstream of the pressure controller, the downstream portion being configured to minimize pressure losses after the fluid has passed through the pressure controller, the secondary flow meter being arranged in the downstream portion.

18. The assembly as claimed in claim 15, wherein the secondary flow meter is more accurate than the main flow meter.

19. The assembly as claimed in claim 18, wherein the accuracy of the secondary flow meter is less than 0.004%.

20. The assembly as claimed in claim 15, wherein the secondary flow meter is based on a physical quantity or phenomenon different from a physical quantity or phenomenon associated with the main flow meter.

21. The assembly as claimed in claim 15, wherein the electronic control unit is configured to modify a resistance of the pressure controller to the flow of the fluid passing through the transfer line, and thus to modify the pressure of the fluid flow passing through the transfer line, the electronic control unit being controlled using a mathematical model and at least one of the following data measured on the fluid flow passing through the transfer line: flow rate, temperature or pressure.

22. The assembly as claimed in claim 21, wherein the flow rate datum is measured by the secondary flow meter located downstream of the pressure controller or by an additional flow meter located upstream or downstream of the pressure controller.

23. The assembly as claimed claim 21, wherein the pressure datum is measured by a pressure sensor arranged upstream of the pressure controller.

24. The assembly as claimed in claim 21, wherein the temperature datum is measured by a temperature sensor arranged upstream of the pressure controller.

25. The assembly as claimed claim 15, wherein the transfer line comprises a safety valve) and/or an automatic valve) configured to protect the simulator in the event of a malfunction.

26. The assembly as claimed in claim 15, wherein the transfer line comprises a check valve configured to enable the fluid to flow from the station to the pressure controller and to prevent the fluid from flowing in the opposite direction.

27. The assembly as claimed in claim 15, wherein the transfer line comprises a receptacle used to recover the fluid and/or to provide a more accurate and stable check of the pressure applied to the secondary flow meter.
